(19) United States
(12) Patent Application Publication
(10) Pub. No.: US 2014/0160057 A1
(43) Pub. Date: Jun. 12, 2014

(54) TOUCH SENSING METHOD AND TOUCH SENSING APPARATUS

(71) Applicant: SAMSUNG ELECTRO-MECHANICS CO., LTD., Suwon (KR)

(72) Inventors: Hyun Suk LEE, Suwon (KR); Tah Joon PARK, Suwon (KR); Kang Joo KIM, Suwon (KR); Yong II KWON, Suwon (KR)

(73) Assignee: SAMSUNG ELECTRO-MECHANICS CO., LTD., Suwon (KR)

(21) Appl. No.: 13/771,655

(22) Filed: Feb. 20, 2013

(30) Foreign Application Priority Data
Dec. 12, 2012 (KR) 10-2012-0144134

(51) Int. Cl. G06F 3/044

(52) U.S. Cl. CPC G06F 3/044
USPC 345/174

(57) ABSTRACT

There is provided a touch sensing method including: classifying sensed pieces of data obtained from a panel unit as a plurality of groups according to a predetermined reference; selecting a portion of groups in which variations of the sensed pieces of data included in each of the plurality of groups are lower than a first threshold value; calculating representative values with respect to each of portion of the groups; and determining a noise canceling method by comparing the variations of representative values with a second threshold value.

### CROSS-REFERENCE TO RELATED APPLICATIONS

This application claims the priority of Korean Patent Application No. 10-2012-0144134 filed on Dec. 12, 2012, in the Korean Intellectual Property Office, the disclosure of which is incorporated herein by reference.

### BACKGROUND OF THE INVENTION

1. Field of the Invention

The present invention relates to a touch sensing method and a touch sensing apparatus capable of effectively canceling or avoiding a noise component introduced to a touchscreen by analyzing sensed pieces of data obtained from a panel unit, determining a noise component affecting in determining a touch, and adjusting filter characteristics, a frequency of a driving signal, or the like.

2. Description of the Related Art

A touch sensing apparatus such as a touchscreen, a touch pad, or the like, is an input device attached to a display device to provide an intuitive input method to a user. Recently, a touch sensing apparatus has been widely applied to various electronic devices such as cellular phones, personal digital assistants (PDAs), navigation devices, and the like. In particular, recently, as demand for smartphones has increased, an employment rate of touchscreens as touch sensing apparatuses capable of providing various input methods in a limited area is on the rise.

Touchscreens employed in portable devices may be classified as resistive-type touchscreens and capacitive-type touchscreens according to a method of sensing a touch utilized thereby. Among these, capacitive touchscreens, having advantages in terms of relatively long lifespans and various easily implementable pieces of data input methods, has been increasingly applied. In particular, the capacitive touchscreen, facilitating implementation of a multi-touch interface relative to the resistive touchscreen, is extensively employed in devices such as smartphones, and the like.

The capacitive touchscreen includes a plurality of electrodes having a predetermined pattern, and a plurality of nodes in which capacitance is changed by a touch are defined by the plurality of electrodes. The plurality of nodes distributed on a two-dimensional (2D) plane generate a change in self-capacitance or in mutual-capacitance according to a touch applied thereto, and coordinates of a touch may be calculated by applying a weighted average calculation method, or the like, to the change in capacitance generated in the plurality of nodes. In order to accurately calculate coordinates of a touch, a cause of a noise component introduced to a touchscreen is required to be accurately analyzed, and a noise canceling/avoiding algorithm optimized for the cause of the found noise component is required to be selectively applied.

Patent document 1 relates to a method for operating a display device using a soft touch, in which an average value of capacitance values obtained from a touch sensor is calculated, and when the average value falls within an operational range, a corresponding command is executed.

Patent document 2 relates to a touch sensor chip using dynamic frequency modulation, in which an operating frequency is hopped according to a hopping sequence. However, Patent documents 1 and 2 do not disclose a technique of dividing sensed pieces of data into a plurality of groups, selecting a portion of a group satisfying particular conditions, and changing filter characteristics or changing a frequency of a driving signal according to a change in a representative value of each of the selected groups.

### RELATED ART DOCUMENT

(Patent document 1) Korean Patent Laid Open Publication No. 10-2011-0054271
(Patent document 2) Korean Patent Laid Open Publication No. 10-2011-0061798

### SUMMARY OF THE INVENTION

An aspect of the present invention provides a touch sensing method and a touch sensing apparatus in which sensed pieces of data obtained from a panel unit is classified into a plurality of groups, a portion of the groups satisfying particular conditions is selected and representative values of the respective groups are calculated, variations of the calculated representative values are compared with a predetermined threshold value to analyze characteristics of a noise component, and an optimal method for avoiding/canceling noise is selected based on the analysis.

According to an aspect of the present invention, there is provided a touch sensing method including: classifying sensed pieces of data obtained from a panel unit as a plurality of groups according to a predetermined reference; selecting a portion of groups in which variations of the sensed pieces of data included in each of the plurality of groups are lower than a first threshold value; calculating representative values with respect to each of portion of the groups; and determining a noise canceling method by comparing the variations of representative values with a second threshold value.

The method may further include: determining that sensed pieces of data included in the remaining groups in which the sensed pieces of data having a variation greater than the first threshold value, has been generated by a touch.

In the calculating of the representative values, any one of an intermediate value and an average value of the sensed pieces of data included in the respective groups may be calculated as the representative value.

The determining may include: adjusting characteristics of a filter filtering the sensed pieces of data when the variations in the representative values are lower than the second threshold value; and changing a frequency of a driving signal applied to the panel unit and initializing the filter, when the variations in the representative values are greater than the threshold value.

In the determining, a frequency of the driving signal may be determined based on the variations in the representative values.

According to an aspect of the present invention, there is provided a touch sensing apparatus including: a sensing circuit unit obtaining sensed pieces of data from a plurality of nodes included in a panel unit; and a calculation unit determining a touch input based on the sensed pieces of data, wherein the calculation unit classifies the sensed pieces of data into a plurality of groups, compares variations of the sensed pieces of data included in each of the plurality of groups with a first threshold value to select a portion of groups including sensed pieces of data having variations lower than the first threshold value, calculates representative values of the portion of the groups, and compares variations in the representative values with the second threshold value to determine a noise canceling method.

The calculation unit may classify the plurality of nodes into a plurality of groups according to a first axis direction, wherein the first axis is parallel to a direction in which driving signals applied to the panel unit are transmitted.

When the variations in the representative values are lower than the second threshold value, the calculation unit may adjust characteristics of a filter filtering the sensed pieces of data, and when the variations in the representative values are greater than the second threshold value, the calculation unit may change a frequency of driving signals applied to the panel unit and initialize the filter.

The calculation unit may determine a frequency of the driving signals base on the variations in the representative values.

The calculation unit may calculate any one of an intermediate value and an average value of the sensed pieces of data included in each of the portion of the groups, as the representative value.

With respect to the remaining groups including sensed pieces of data having variations greater than the first threshold value, the calculation unit may determine that the sensed pieces of data included in the remaining groups have been generated by a touch.

According to an aspect of the present invention, there is provided a touch sensing apparatus including: a plurality of first electrodes receiving driving signals; a plurality of second electrodes intersecting the plurality of first electrodes; and a controller integrated circuit (IC) obtaining sensed pieces of data from the plurality of second electrodes through a plurality of sensing channels, wherein the controller IC classifies the sensed pieces of data as a plurality of groups according to the plurality of first electrodes to which the driving signals are applied, compares variations of sensed pieces of data included in each of the plurality of groups with a first threshold value to select a portion of the groups including sensed pieces of data having variations lower than the first threshold value, calculates representative values of each of the portion of the groups, and compares the variations in the representative values with a second threshold value to determine a noise canceling method.

When the variations in the representative values are lower than the second threshold value, the controller IC may adjust characteristics of a filter filtering the sensed pieces of data, and when the variations in the representative values are greater than the second threshold value, the controller IC may initialize the filter.

The controller IC may calculate any one of an intermediate value and an average value of the sensed pieces of data included in each of the portion of the groups, as the representative value.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating the exterior of an electronic device including a touch sensing apparatus according to an embodiment of the present invention;

FIG. 2 is a view illustrating a touchscreen panel unit that may be included in the touch sensing apparatus according to an embodiment of the present invention;

FIG. 3 is a circuit diagram of the touch sensing apparatus according to an embodiment of the present invention;

FIG. 4 is a flow chart illustrating a touch sensing method according to an embodiment of the present invention; and

FIG. 5 is a graph showing an operation of the touch sensing apparatus according to an embodiment of the present invention.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

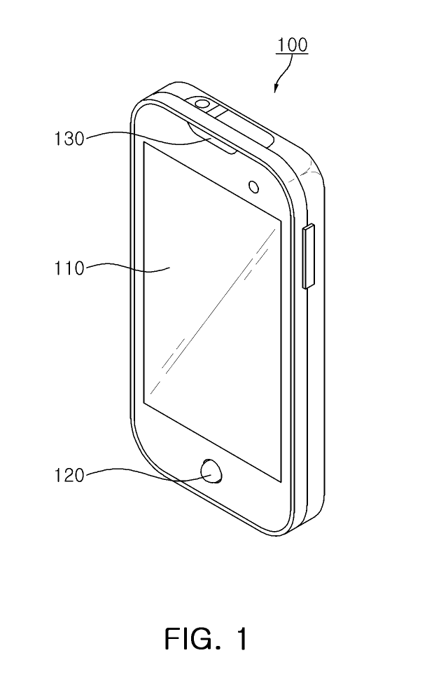

FIG. 1 is a perspective view illustrating the exterior of an electronic device including a touch sensing apparatus according to an embodiment of the present invention.

Referring to FIG. 1, an electronic device 100 according to the present embodiment may include a display unit 110 for outputting a screen, an input unit 120, an audio output unit 130 for outputting audio, and the like, and also, a touch sensing apparatus integrated with the display unit 110.

As illustrated in FIG. 1, in case of the mobile device, in general, a touch sensing apparatus is integrated with the display unit, and the touch sensing apparatus is required to have sufficient light transmittance to allow an image displayed on the display unit to be transmitted therethrough. Thus, the touch sensing apparatus may be implemented by forming a sensing electrode with a material such as indium tin oxide (ITO), indium zinc oxide (IZO), zinc oxide (ZnO), carbon nanotubes (CNT), or graphene having electrical conductivity on a base substrate made of a transparent film material such as polyethylene terephthalate (PET), polycarbonate (PC), polyethersulfone (PES), polyimide (PI), or the like. A wiring pattern connected to the sensing electrode made of a transparent conductive material is disposed in a bezel region of the display unit, and since the wiring pattern is visually shielded by the bezel region, the wiring pattern may also be made of a metal such as silver (Ag), copper (Cu), or the like.

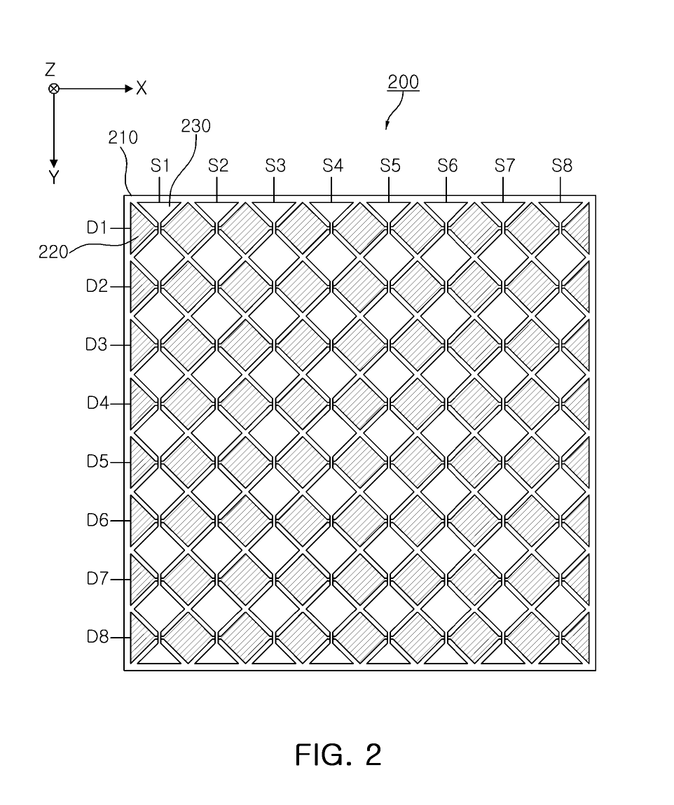

Of course, the touch sensing apparatus according to an embodiment of the present invention is assumed to operate according to a capacitive scheme, so it may include a plurality of electrodes having a predetermined pattern. Also, the touch sensing apparatus according to an embodiment of the present invention may include a capacitance sensing circuit detecting a change in capacitance generated by a plurality of electrodes, an analog-to-digital conversion circuit converting an output signal from the capacitance sensing circuit into a digital value, a calculation circuit determining a touch by using pieces of data which has been converted into the digital value, and the like. Hereinafter, the touch sensing apparatus and an operation method thereof according to an embodiment of the present invention will be described with reference to FIGS. 2 through 7.

FIG. 2 is a view illustrating a touchscreen panel unit that may be included in the touch sensing apparatus according to an embodiment of the present invention.

Referring to FIG. 2, a panel screen 200 according to the present embodiment includes a substrate 210 and a plurality of sensing electrodes 220 and 230 provided on the substrate 210. Although not shown, the plurality of sensing electrodes 220 and 230 may be electrically connected to a wiring pattern of a circuit board attached to one end of the substrate 210 through a wiring and a bonding pad, respectively. A controller integrated circuit (IC) may be mounted on the circuit board to detect sensing signals generated by the plurality of sensing electrodes 220 and 230 and determine a touch from the sensing signals.

In the case of the touchscreen device, the substrate 210 may be a transparent substrate on which the sensing electrodes 220 and 230 are formed, and may be made of a plastic material such as polyimide (PI), polymethylmethacrylate (PMMA), polyethyleneterephthalate (PET), or polycarbonate (PC), or tempered glass. Besides a region in which the sensing electrodes 220 and 230 are formed, a predetermined printed region for visually shielding a wiring generally made of an opaque metal may be formed on the substrate 210 with respect to a region in which the wiring connected to the sensing electrodes 220 and 230 is provided.

The plurality of sensing electrodes 220 and 230 may be formed on one surface of the substrate 210 or on both surfaces thereof. The touchscreen device may be made of ITO, IZO, ZnO, CNT, a graphene material, or the like, which has transparency and conductivity. In FIG. 2, the sensing electrodes 220 and 230 having a diamond-like pattern are illustrated, but the present invention is not limited thereto and the sensing electrodes 220 and 230 may also have various polygonal patterns such as a rectangular pattern, a triangular pattern, or the like.

The plurality of sensing electrodes 220 and 230 include first electrodes 220 extending in an X-axial direction and second electrodes 230 extending in a Y-axial direction. The first electrodes 220 and the second electrodes 230 may be formed on both surfaces of the substrate 210 or may be alternately formed on mutually different substrates 210. In the case in which both the first electrodes 220 and the second electrodes 230 are formed on one surface of the substrate 210, a predetermined insulating layer may be partially formed in intersections between the first electrodes 220 and the second electrodes 230.

The touch sensing apparatus, electrically connected to the plurality of sensing electrodes 220 and 230 to sense a touch, may detect a change in capacitance generated from the plurality of sensing electrodes 220 and 230 according to a touch applied thereto, and sense the touch based on the detected change in capacitance. The first electrodes 220 may be connected to channels defined as D1 to D8 in the control IC to receive a predetermined driving signal, and the second electrode 230 may be connected to channels defined as S1 to S8 so as to be used for the touch sensing apparatus to detect a sensing signal. Here, the controller IC may detect a change in mutual capacitance generated between the first electrodes 220 and the second electrodes 230, as a sensing signal, and operate to sequentially apply a driving signal to the respective first electrodes 220 and simultaneously detect a change in the capacitance in the second electrodes 230. Namely, when M number of first electrodes 220 and N number of second electrodes 230 are provided, the controller IC may detect M×N number of capacitance change pieces of data for determining a touch.

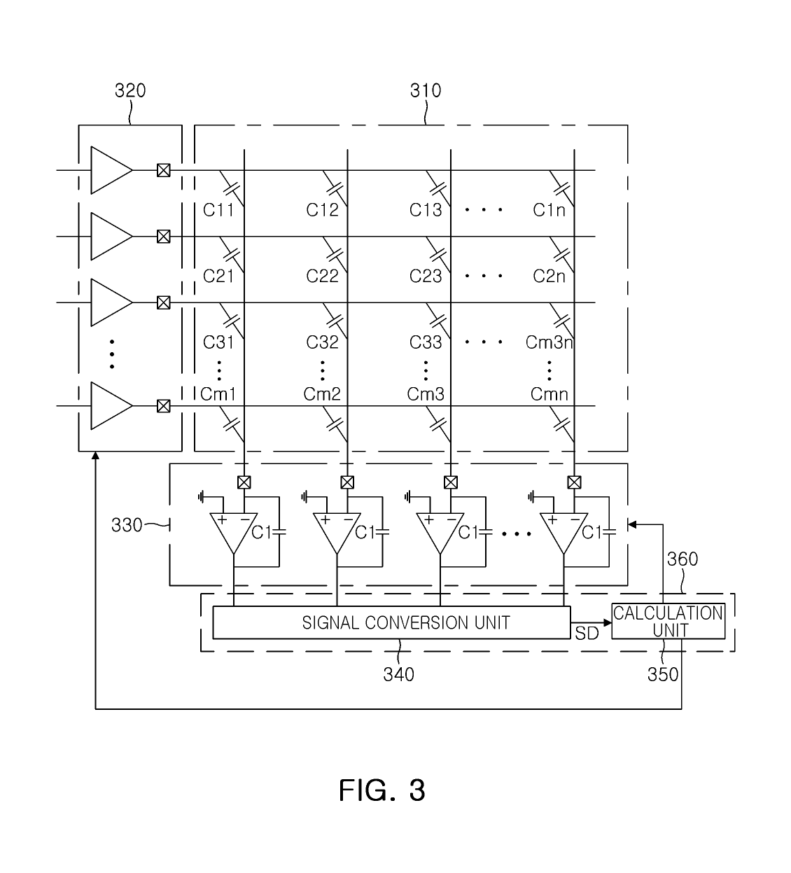

FIG. 3 is a circuit diagram of the touch sensing apparatus according to an embodiment of the present invention.

Referring to FIG. 3, the touch sensing apparatus according to an embodiment of the present invention includes a panel unit 310, a driving circuit unit 320, a sensing circuit unit 330, a signal conversion unit 340, and a calculation unit 350. The panel unit 310 includes m number of first electrodes extending in a first axial direction (or a horizontal direction in FIG. 3) and n number of second electrodes extending in a second axial direction (or a vertical direction in FIG. 3) crossing the first axis. Capacitance changes C11 to Cmn are generated in a plurality of nodes at which the first electrodes and the second electrodes intersect. The capacitance changes C11 to Cmn generated in the plurality of nodes may be changes in mutual capacitance generated by a driving signal applied to the first electrodes by the driving circuit unit 320. Meanwhile, the driving circuit unit 320, the sensing circuit unit 330, the signal conversion unit 340, and the calculation unit 350 may be implemented as a single integrated circuit (IC).

The driving circuit unit 320 applies a predetermined driving signal to the first electrodes. The driving signal may have a square wave form, a sine wave form, a triangle wave form, or the like, having a predetermined period and amplitude, and may be sequentially applied to the plurality of respective first electrodes. In FIG. 3, circuits for generating and applying driving signals are individually connected to the plurality of respective first electrodes, but the present invention is not limited thereto and it may be configured such that a single driving signal generation circuit is provided and a driving signal may be applied to a plurality of respective first electrodes by using a switching circuit. Also, the driving signal may be simultaneously applied to all the first electrodes or may be selectively applied to only a portion of the first electrodes to simply detect presence or absence of a touch.

The sensing circuit unit 330 may include an integrating circuit for sensing the capacitance changes C11 to Cmn generated in the plurality of nodes. The integrating circuit may be connected to the plurality of second electrodes. The integrating circuit may include at least one operational amplifier and a capacitor C1 having a certain capacity. An inverting input terminal of the operational amplifier is connected to the second electrode to convert capacitance changes C11 to Cmn into an analog signal such as a voltage signal, or the like, and output the same. When driving signals are sequentially applied to the plurality of respective first electrodes, capacitance changes may be simultaneously detected from the plurality of second electrodes, so n number of integrating circuits corresponding to the second electrodes may be provided.

The signal conversion unit 340 generates a digital signal SD from the analog signal generated by the integrating circuit. For example, the signal conversion unit 340 may include a time-to-digital converter (TDC) circuit measuring a time during which an analog signal in a voltage form output by the sensing circuit unit 330 reaches a predetermined reference voltage level and converting the same into a digital signal SD, or may include an analog-to-digital converter (ADC) circuit measuring an amount by which a level of an analog signal output by the sensing circuit unit 330 changes for a predetermined time and converting the same into a digital signal SD. The calculation unit 350 may determine a touch applied to the panel unit 310 by using the digital signal SD. In an embodiment of the present invention, the calculation unit 350 may determine a number of touches applied to the panel unit 310, coordinates of a touch, a gesture, or the like.

The digital signal SD used as a reference for the calculation unit 350 to determine a touch may be pieces of data obtained by digitizing the capacitance changes C11 to Cmn, and in particular, it may be pieces of data indicating a difference of capacitance between a case in which a touch has not been generated and a case in which a touch has been generated. In general, in a touch sensing apparatus based on a capacitance scheme, a region in which a conductive object is in contact has reduced capacitance relative to a region in which a touch has not been applied.

In order to effectively cancel a noise component included in the digital signal SD, the calculation unit 350 may use a filter or change characteristics of a driving signal applied to the panel unit 310 from the driving circuit unit 320. Which filter is to be applied to the digital signal SD, which coefficient value of a filter is to be set, how a frequency and level of a driving signal is to be set by the calculation unit 350 may be determined according to characteristics of a noise component introduced to the panel unit 310.

In order to determine characteristics of a noise component, the calculation unit 350 may classify the digital signals SD into a plurality of groups, and calculate variations, average values, or the like, of the digital signals SD included in the respective groups. The calculation unit 350 compares the calculated variations or average values with a first threshold value, and determines that a group having a variation or an average value greater than the first threshold value, as a group which has been actually touched by the user, and exclude the corresponding group in a follow-up calculation.

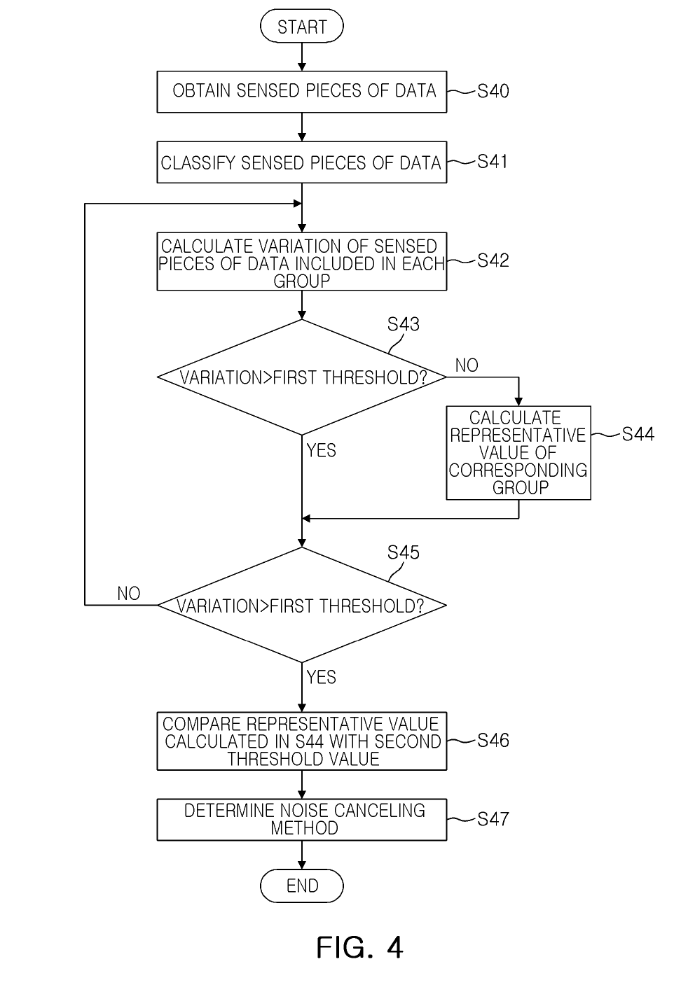

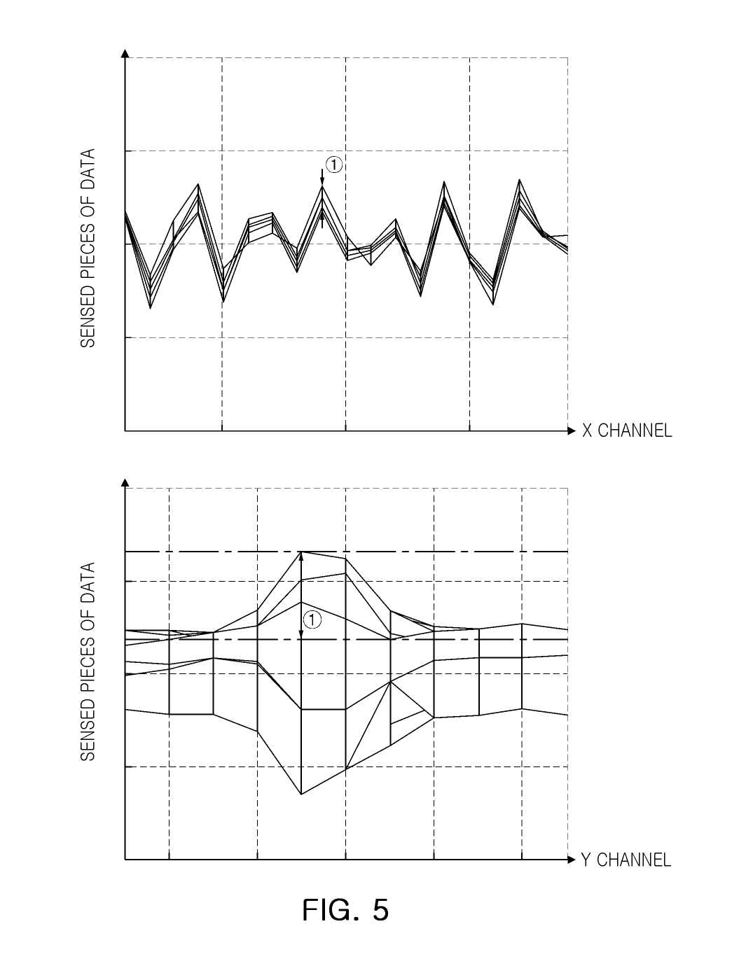

With respect to a group having a variation or an average value lower than the first threshold value, the calculation unit 350 calculates a representative value with respect to the digital signals SD included in the corresponding group. The calculation unit 350 may compare the calculated representative value with a second threshold value and determine a noise canceling method, such as filter application, frequency hopping of driving signals, or the like. This will be described in detail with reference to FIGS. 4 and 5, hereinafter.

FIG. 4 is a flow chart illustrating a touch sensing method according to an embodiment of the present invention.

Referring to FIG. 4, a touch sensing method according to the present embodiment starts with the calculation unit 350 obtaining sensed pieces of data from the panel unit 310 (S40). As described above with reference to FIG. 3, the driving circuit unit 320 may sequentially apply driving signals to the respective first electrodes of the panel unit 310, and the sensing circuit unit 330 may detect a change in capacitance from the second electrodes to generate sensed pieces of data.

The calculation unit 350 classifies the obtained sensed pieces of data as a plurality of groups (S41). Various references may be used to classify the sensed pieces of data as a plurality of groups, and simply, sensed pieces of data of the respective first electrodes to which the driving signals are applied may be classified. For example, when it is assumed that the panel unit 310 includes a total of ten first electrodes X1 to X10 and a total of eight second electrodes Y1 to Y8, the calculation unit 350 may obtain eighty sensed pieces of data from eighty nodes each time a single scan and sensed pieces of data obtaining operation performed on the panel unit 310 is completed. Here, the calculation unit 350 may classify eighty sensed pieces of data into ten groups. The respective ten groups include eight sensed pieces of data, and eight sensed pieces of data included in the same group correspond to sensed pieces of data obtained from the second electrodes when driving signals are applied to particular first electrodes.

After the sensed pieces of data are classified, the calculation unit 350 calculates variations of the sensed pieces of data included in the respective groups (S42) and compares the calculated variations with a first threshold value (S43). For example, in the case of the ten first electrodes and eight second electrodes, variations of the sensed pieces of data included in the respective groups may be deviations between maximum values and minimum vales of the eight sensed pieces of data included in the respective 10 groups. This will be described with reference to FIG. 5, hereinafter.

FIG. 5 is a graph showing an operation of the touch sensing apparatus according to an embodiment of the present invention.

A first graph in FIG. 5 represents sensed pieces of data obtained by the respective first electrodes in a state that a touch is not applied. Since a touch has not been applied, there are differences according to reference values of the plurality of respective first electrodes, but sensed pieces of data obtained with respect to the same first electrodes, i.e., values identical in the X-axis, do not have a significant deviation. Namely, in the first graph of FIG. 5, deviations indicated by may be ‘variations of sensed pieces of data included in the respective groups’ calculated by the calculation unit 350 in operation S42.

A second graph in FIG. 5 represents sensed pieces of data obtained by respective second electrodes in a state that a touch is applied. Since a touch has been applied, there are very large deviations in the sensed pieces of data obtained from a portion of the second electrodes as illustrated in FIG. 5. A group including sensed pieces of data representing very large deviations as shown in the second graph of FIG. 5 is excluded in a follow-up process of the touch sensing method proposed in the present embodiment.

When the variation calculated in operation S43 is lower than a first threshold value, the calculation unit 350 calculates a representative value that may represent sensed pieces of data included in a corresponding group (S44). In operation S44, the calculation unit may calculate a maximum deviation of sensed pieces of data included in a corresponding group, as a representative value. Meanwhile, when the variation calculated in operation S43 is greater than the first threshold value, the calculation unit 350 excludes the corresponding group in a follow-up calculation. If the variation calculated in step S43 is greater than the first threshold value, it means that sensed pieces of data generated by a touch is highly likely to be included in the corresponding group. Thus, in reversely analyzing the characteristics of corresponding noise components from sensed pieces of data generated by noise and determining a noise canceling method accordingly, preferably, a group having a variation greater than the first threshold value is not applied.

After applying operations S43 and S44 to all the groups, the calculation unit 350 compares the representative values calculated in operation S44 with a second threshold value (S46), and determines a noise canceling method based on the comparison result (S47). For example, in case that the representative values calculated in operation S44 are lower than the second threshold value, the calculation unit 350 may determine that noise components introduced into the nodes from which the sensed pieces of data of the corresponding group may be canceled through a simple filter factor or order adjustment. Thus, the calculation unit 350 may effectively cancel the noise component by appropriately changing a filter factor of a filter filtering sensed pieces of data or order.

Meanwhile, when the representative values calculated in operation S44 is greater than the second threshold value, the calculation unit 350 may determine that the noise component introduced to the nodes from which the sensed pieces of data of the corresponding group has been output may not be easily canceled through a simple filter adjustment. Thus, the calculation unit 350 may cancel a noise component by changing a level or a frequency of a driving signal applied by the driving circuit unit 320 to the panel unit 310.

Here, a reference for adjusting the frequency of the driving signal by the calculation unit 350 may be determined based on a change in a sign of a representative value of each of the plurality of groups, or the like. For example, when sensed pieces of data are classified by first electrodes, it can be seen that a sign of the representative value in the first graph of FIG. 5 has been changed a total of thirteen times. Since the sign of the representative value of each group is changed thirteen times, a period thereof is given 6.5. Namely, the calculation unit 350 may adjust a direction of frequency hopping of driving signals and a magnitude of the driving signals based on the number indicating a change in a sign of each the representative values exhibiting characteristics of sensed pieces of data of respective groups.

As set forth above, according to embodiments of the invention, sensed pieces of data is classified into a plurality of groups, a portion of groups satisfying particular conditions are selected from the plurality of groups, and representative values of the respective selected groups. Variations of the calculated representative values are compared with a predetermined threshold value, and characteristics of a noise component are analyzed according to the comparison results. Thus, a noise canceling method capable of most effectively avoiding or canceling noise components generated due to different causes can be selectively applied.

While the present invention has been shown and described in connection with the embodiments, it will be apparent to those skilled in the art that modifications and variations can be made without departing from the spirit and scope of the invention as defined by the appended claims.

What is claimed is:

1. A touch sensing method comprising:
classifying sensed pieces of data obtained from a panel unit as a plurality of groups according to a predetermined reference;
selecting a portion of groups in which variations of the sensed pieces of data included in each of the plurality of groups are lower than a first threshold value;
calculating representative values with respect to each of portion of the groups; and
determining a noise canceling method by comparing the variations of representative values with a second threshold value.

2. The method of claim 1, further comprising:
determining that sensed pieces of data included in the remaining groups in which the sensed pieces of data having a variation greater than the first threshold value, has been generated by a touch.

3. The method of claim 1, wherein in the calculating of the representative values, any one of an intermediate value and an average value of the sensed pieces of data included in the respective groups, is calculated as the representative value.

4. The method of claim 1, wherein the determining comprises:
adjusting characteristics of a filter filtering the sensed pieces of data when the variations in the representative values are lower than the second threshold value; and
changing a frequency of a driving signal applied to the panel unit and initializing the filter, when the variations in the representative values are greater than the threshold value.

5. The method of claim 4, wherein in the determining, a frequency of the driving signal is determined based on the variations in the representative values.

6. A touch sensing apparatus comprising:
a sensing circuit unit obtaining sensed pieces of data from a plurality of nodes included in a panel unit; and
a calculation unit determining a touch input based on the sensed pieces of data,
wherein the calculation unit classifies the sensed pieces of data into a plurality of groups, compares variations of the sensed pieces of data included in each of the plurality of groups with a first threshold value to select a portion of groups including sensed pieces of data having variations lower than the first threshold value, calculates representative values of the portion of the groups, and compares variations in the representative values with the second threshold value to determine a noise canceling method.

7. The touch sensing apparatus of claim 6, wherein the calculation unit classifies the plurality of nodes into a plurality of groups according to a first axis direction,
wherein the first axis is parallel to a direction in which driving signals applied to the panel unit are transmitted.

8. The touch sensing apparatus of claim 6, wherein when the variations in the representative values are lower than the second threshold value, the calculation unit adjusts characteristics of a filter filtering the sensed pieces of data, and when the variations in the representative values are greater than the second threshold value, the calculation unit changes a frequency of driving signals applied to the panel unit and initialize the filter.

9. The touch sensing apparatus of claim 8, wherein the calculation unit determines a frequency of the driving signals base on the variations in the representative values.

10. The touch sensing apparatus of claim 6, wherein the calculation unit calculates any one of an intermediate value and an average value of the sensed pieces of data included in each of the portion of the groups, as the representative value.

11. The touch sensing apparatus of claim 6, wherein with respect to the remaining groups including sensed pieces of data having variations greater than the first threshold value, the calculation unit determines that the sensed pieces of data included in the remaining groups have been generated by a touch.

12. A touch sensing apparatus comprising:
a plurality of first electrodes receiving driving signals;
a plurality of second electrodes intersecting the plurality of first electrodes; and
a controller integrated circuit (IC) obtaining sensed pieces of data from the plurality of second electrodes through a plurality of sensing channels,
wherein the controller IC classifies the sensed pieces of data as a plurality of groups according to the plurality of first electrodes to which the driving signals are applied, compares variations of sensed pieces of data included in each of the plurality of groups with a first threshold value to select a portion of the groups including sensed pieces of data having variations lower than the first threshold value, calculates representative values of each of the portion of the groups, and compares the variations in the representative values with a second threshold value to determine a noise canceling method.

13. The touch sensing apparatus of claim 12, wherein when the variations in the representative values are lower than the second threshold value, the controller IC adjusts characteristics of a filter filtering the sensed pieces of data, and when the variations in the representative values are greater than the second threshold value, the controller IC initializes the filter.

14. The touch sensing apparatus of claim 12, wherein the controller IC calculates any one of an intermediate value and an average value of the sensed pieces of data included in each of the portion of the groups, as the representative value.
